(19) United States
(12) Patent Application Publication
(10) Pub. No.: US 2023/0180656 A1
(43) Pub. Date: Jun. 15, 2023

(54) Lawnmower String Line Adapter Blade Device

(71) Applicant: John D. Chaudron, Rosedale, MD (US)

(72) Inventor: John D. Chaudron, Rosedale, MD (US)

(21) Appl. No.: 17/742,557

(22) Filed: May 12, 2022

Related U.S. Application Data
(60) Provisional application No. 63/289,246, filed on Dec. 14, 2021.

(51) Int. Cl. A01D 34/416; A01D 34/73

(52) U.S. Cl. CPC A01D 34/416; A01D 34/733; A01D 2101/00

(57) ABSTRACT

The present invention relates to a lawnmower string line adapter blade device primarily comprised of a body further comprised of a top surface, a bottom surface, at least one central fastener opening, at least one central string opening, at least one perimeter string opening, and at least one string. In the preferred embodiment, the body is generally circular in shape and can be attached via at least one fastener that is placed through a central fastener opening to the blade mounting area of a lawnmower. The central string openings and perimeter string openings further surround the central fastener opening in a radial fashion such that the string can be woven through the central string openings and the perimeter string openings to be secured to the body. In the preferred embodiment, a plurality of separate nylon strings are woven through the openings to create quasi-blades.

### CROSS-REFERENCE TO RELATED APPLICATION

The present application claims priority to, and the benefit of, U.S. Provisional Application No. 63/289,246 which was filed on Dec. 14, 2021, and is incorporated herein by reference in its entirety.

### FIELD OF THE INVENTION

The present invention relates generally to the field of lawnmower blades. More specifically, the present invention relates to a lawnmower string line adapter blade device primarily comprised of a body further comprised of a top surface, a bottom surface, at least one central fastener opening, at least one central string opening, at least one perimeter string opening, and at least one string. In the preferred embodiment, the body is generally circular in shape and can be attached via at least one fastener that is placed through a central fastener opening to the blade mounting area of a lawnmower. The central string openings and perimeter string openings further surround the central fastener opening in a radial fashion such that the string can be woven through the central string openings and the perimeter string openings to be secured to the body. In the preferred embodiment, a plurality of separate nylon strings are woven through the openings to create quasi-blades that can be easily replaced and cannot create dangerous impact strikes. Accordingly, the present disclosure makes specific reference thereto. Nonetheless, it is to be appreciated that aspects of the present invention are also equally applicable to other like applications, devices and methods of manufacture.

### BACKGROUND

Lawnmowers are owned by most individuals who have small yards. However, lawnmower blades require significant maintenance to remain fully functional. Said maintenance involves removing and sharpening the metal blades of the lawnmower. Not only is this process potentially dangerous, but the metal blades themselves are dangerous when spinning as they can impact blunt objects like rocks which can damage the blades and shaft of the lawnmower and decrease the lifespan of the mower. Further, metal blades can easily cut off fingers or toes if said digits come in contact with the blades as they are spinning.

Therefore, there exists a long-felt need in the art for an improved lawnmower blade. There also exists a long-felt need in the art for a lawnmower string line adapter blade device that allows a non-traditional blade type to be used with a lawnmower. Further, there exists a long-felt need in the art for a lawnmower string line adapter blade device that allows a non-traditional blade type to be used with a lawnmower, wherein said blade type does not utilize metal blades. In addition, there exists a long-felt need in the art for a lawnmower string line adapter blade device that allows a non-traditional blade type to be used with a lawnmower, wherein said blade type does not utilize metal blades and said blade type is not prone to damage from hitting rocks or other obstructions while mowing.

The subject matter disclosed and claimed herein, in one embodiment thereof, comprises a lawnmower string line adapter blade device. The device is primarily comprised of a body further comprised of a top surface, a bottom surface, at least one central fastener opening, at least one central string opening, at least one perimeter string opening, and at least one string. In the preferred embodiment, the body is generally circular in shape and can be attached via at least one fastener that is placed through a central fastener opening to the blade mounting area of a lawnmower. The central string openings and perimeter string openings further surround the central fastener opening in a radial fashion such that the string can be woven through the central string openings and the perimeter string openings to be secured to the body. In the preferred embodiment, a plurality of separate nylon strings are woven through the openings to create quasi-blades that can be easily replaced and cannot create dangerous impact strikes.

In this manner, the lawnmower string line adapter blade device of the present invention accomplishes all of the forgoing objectives and provides an improved lawnmower blade that does not utilize metal blades and, as a result, is not prone to damage from hitting rocks or other obstructions while mowing. Therefore, the lawnmower string line adapter blade device overcomes the limitations of existing lawnmower blades known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a lawnmower string line adapter blade device. The device is primarily comprised of a body further comprised of a top surface, a bottom surface, at least one central fastener opening, at least one central string opening, at least one perimeter string opening, and at least one string. In the preferred embodiment, the body is generally circular in shape and is made from a durable metal such as, but not limited to, stainless steel, aluminum, hot-rolled mild steel. The body is further comprised of at least one central fastener opening that allows at least one fastener to be used to secure the body to the blade mounting area on the bottom surface of a lawnmower.

In the preferred embodiment, the body has a plurality of central string openings which are positioned radially around the central fastener opening. In differing embodiments, said openings may be arranged in a paired configuration around the top, bottom, left, and right sides of the central fastener opening. Similarly, the body preferably has a plurality of perimeter string openings positioned radially around the central fastener opening and central string openings. In differing embodiments, said openings may be arranged in a singular configuration around the top, bottom, left, and right sides of the central fastener opening and central string openings.

The device is also comprised of at least one string that is preferably manufactured from hardened monofilament nylon and is generally cylindrical in shape. One piece of string can be woven through a set of central string openings from the bottom surface and then through a perimeter string opening from the top surface such that the string is secured to the body without the need for any additional fasteners. In the preferred embodiment, multiple strings can be woven in this fashion in a radial manner around the central fastener opening, wherein each string then forms a quasi-blade. Therefore, when the lawnmower is powered on the body will spin, which causes each string to spin and cut any grass it meets. Because of the material of the string, the string will simply flex or break harmlessly if a rock or other hard debris is impacted. Further, because of the easy weaving attachment method, a user can easily replace broken strings as necessary.

Accordingly, the lawnmower string line adapter blade device of the present invention is particularly advantageous as it provides an improved lawnmower blade. The non-traditional blade type of the device does not utilize metal blades and therefore is not prone to damage from hitting rocks or other obstructions while mowing. In this manner, the lawnmower string line adapter blade device overcomes the limitations of existing lawnmower blades known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates multiple perspective views of one potential embodiment of a lawnmower string line adapter blade device of the present invention in accordance with the disclosed architecture;

FIG. 2 illustrates a bottom perspective view of one potential embodiment of a lawnmower string line adapter blade device of the present invention while attached to a lawnmower in accordance with the disclosed architecture;

FIG. 3 illustrates a top and bottom perspective view of one potential embodiment of a lawnmower string line adapter blade device of the present invention in accordance with the disclosed architecture; and

FIG. 4 illustrates a cross-sectional view of one potential embodiment of a lawnmower string line adapter blade device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved lawnmower blade. There also exists a long-felt need in the art for a lawnmower string line adapter blade device that allows a non-traditional blade type to be used with a lawnmower. Further, there exists a long-felt need in the art for a lawnmower string line adapter blade device that allows a non-traditional blade type to be used with a lawnmower, wherein said blade type does not utilize metal blades. In addition, there exists a long-felt need in the art for a lawnmower string line adapter blade device that allows a non-traditional blade type to be used with a lawnmower, wherein said blade type does not utilize metal blades and said blade type is not prone to damage from hitting rocks or other obstructions while mowing.

The present invention, in one exemplary embodiment, is comprised of a lawnmower string line adapter blade device primarily comprised of a body further comprised of a top surface, a bottom surface, at least one central fastener opening, at least one central string opening, at least one perimeter string opening, and at least one string. In the preferred embodiment, the body is generally circular in shape and is made from a durable metal such as but not limited to, stainless steel, aluminum, hot-rolled mild steel, etc. The body is further comprised of at least one central fastener opening that allows at least one fastener to be used to secure the body to the blade mounting area on the bottom surface of a lawnmower.

In the preferred embodiment the body also has a plurality of central string openings which are positioned radially around the central fastener opening. Said openings may be arranged in a paired configuration around the top, bottom, left, and right sides of the central fastener opening in differing embodiments. Similarly, the body preferably has a plurality of perimeter string openings positioned radially around the central fastener opening and central string openings. In differing embodiments, said openings may be arranged in a singular configuration around the top, bottom, left, and right sides of the central fastener opening and central string openings.

In addition, the device is comprised of least one string that is preferably manufactured from hardened monofilament nylon and is generally cylindrical in shape. One piece of string can be woven through a set of central string openings from the bottom surface and then through a perimeter string opening from the top surface such that the string is secured to the body without the need for any additional fasteners. In the preferred embodiment, multiple strings can be woven in this fashion in a radial manner around the central fastener opening, wherein each string then forms a quasi-blade. Therefore, when the lawnmower is powered on, the body will spin, which causes each string to spin and cut any grass it comes into contact with. Because of the material of the string, the string will simply break harmlessly if a rock or other hard debris is impacted. Further, because of the easy weaving attachment method, a user can easily replace broken strings as necessary.

Accordingly, the lawnmower string line adapter blade device of the present invention is particularly advantageous as it provides an improved lawnmower blade. The non-traditional blade type of the device does not utilize metal blades and is not prone to damage from hitting rocks or other obstructions while mowing. In this manner, the lawnmower string line adapter blade device overcomes the limitations of existing lawnmower blades known in the art.

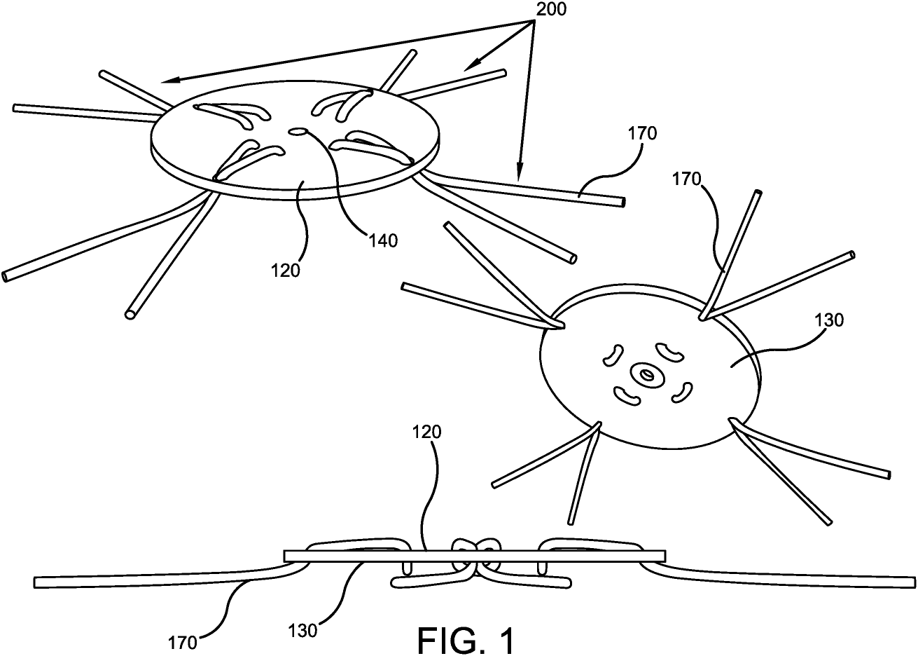

Referring initially to the drawings, FIG. 1 illustrates multiple perspective views of one potential embodiment of a lawnmower string line adapter blade device 100 of the present invention in accordance with the disclosed architecture. The device 100 is primarily comprised of a body 110, further comprised of a top surface 120, a bottom surface 130, at least one central fastener opening 140, at least one central string opening 150, at least one perimeter string opening 160, and at least one string 170. In the preferred embodiment, the body 110 is generally circular in shape and is made from a durable metal such as, but not limited to, stainless steel, aluminum, hot-rolled mild steel, etc. However, in differing embodiments the body 110 may be any shape such as, but not limited to: square, triangular, oval, polygonal, etc. Further, the body 110 may be made from a rigid plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc.

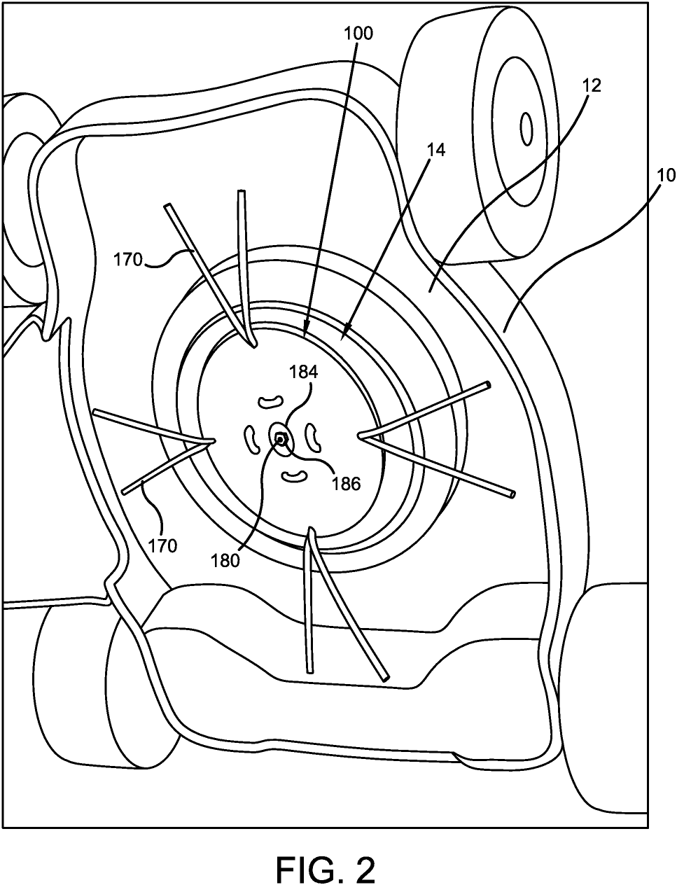

The body 110 is further comprised of at least one central fastener opening 140. The opening 140 allows at least one fastener 180 to be used to secure the body 110 to the blade mounting area 14 on the bottom surface 12 of a lawnmower 10, as seen in FIG. 2. Said fastener 180 can include, but is not limited to: screw, bolt, magnet, etc. The device 100 may also be comprised of at least one washer 184 and at least one nut 186 of any type known in the art that aids the fastener 180 in remaining attached to the device 100 and lawnmower 10.

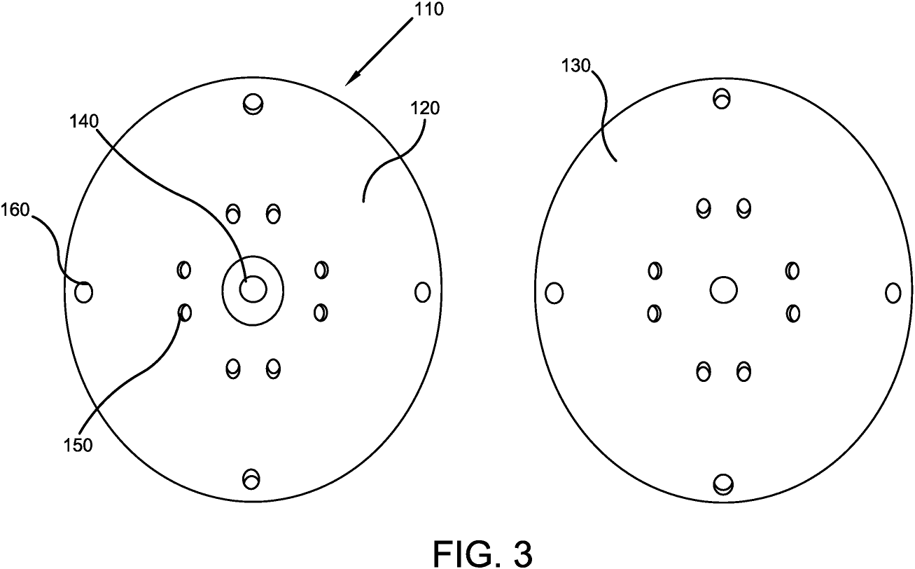

FIG. 3 illustrates a top and bottom perspective view of one potential embodiment of a lawnmower string line adapter blade device 100 of the present invention in accordance with the disclosed architecture. As noted, the body 110 has at least one, but preferably a plurality of central string openings 150. Said openings 150 are positioned radially around the central fastener opening 140. In differing embodiments, said openings 150 may be arranged in a paired configuration around the top, bottom, left, and right sides of the central fastener opening 140, as shown in FIG. 1 and FIG. 3. However, the openings 150 may be positioned in any orientation around the fastener opening 140 in differing embodiments.

Similarly, the body 110 has at least one, but preferably a plurality of perimeter string openings 160. Said openings 160 are positioned radially around the central fastener opening 140 and central string openings 150. In differing embodiments, said openings 160 may be arranged in a singular configuration around the top, bottom, left, and right sides of the central fastener opening 140 and central string openings 150, as shown in FIG. 1 and FIG. 3. However, the openings 160 may be positioned in any orientation around the fastener opening 140 and string openings 150 in differing embodiments.

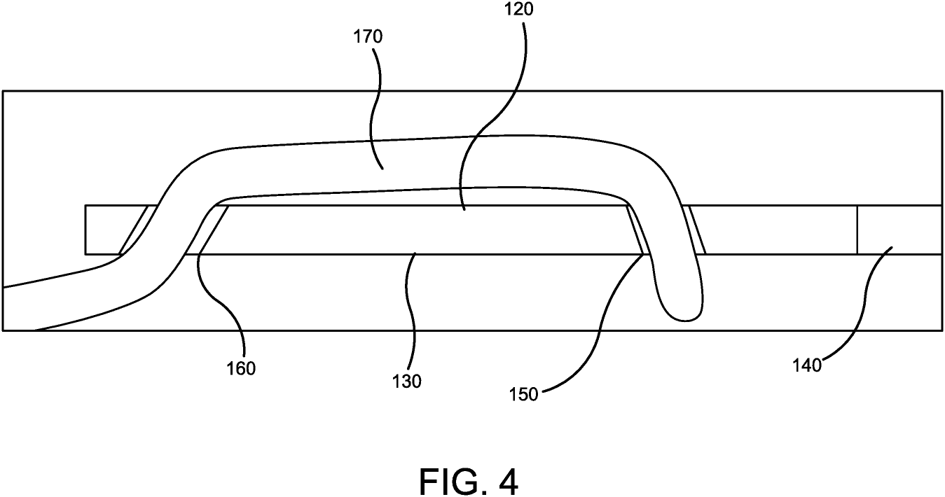

The device 100 is also comprised of at least one string 170. The string 170 is preferably manufactured from hardened monofilament nylon that is generally cylindrical in shape. One piece of string 170 can be woven through a set of central string openings 150 from the bottom surface 130 and then through a perimeter string opening 160 from the top surface 120, as best seen in FIG. 4 and FIG. 1. In this manner, the pattern in which the string 170 is woven through the openings 150,160 secures the string 170 to the body 110 without the need for any additional fasteners. In the preferred embodiment, multiple strings 170 can be woven in this fashion in a radial manner around the central fastener opening 140, wherein each string 170 then forms a quasi-blade. Therefore, when the lawnmower 10 is powered on, the body 110 will spin, which causes each string 170 to spin and cut any grass it comes into contact with. Because of the material of the string 170, the string 170 will simply break harmlessly if a rock or other hard debris is impacted. Further, because of the easy weaving attachment method, a user can easily replace broken strings 170 as necessary. In one embodiment, the device 100 may be comprised of a kit 200 of a plurality of precut strings 170, wherein all strings 170 of the kit 200 are of the same or differing size.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “lawnmower string line adapter blade device” and “device” are interchangeable and refer to the lawnmower string line adapter blade device 100 of the present invention.

Notwithstanding the foregoing, the lawnmower string line adapter blade device 100 of the present invention and its various components can be of any suitable size and configuration as is known in the art without affecting the overall concept of the invention, provided that they accomplish the above-stated objectives. One of ordinary skill in the art will appreciate that the size, configuration and material of the lawnmower string line adapter blade device 100 as shown in the FIGS. are for illustrative purposes only, and that many other sizes and shapes of the lawnmower string line adapter blade device 100 are well within the scope of the present disclosure. Although the dimensions of the lawnmower string line adapter blade device 100 are important design parameters for user convenience, the lawnmower string line adapter blade device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lawnmower string line adapter blade device comprising:
a body having a central fastener opening, a central string opening, and a perimeter string opening;
a fastener; and
a string.

2. The lawnmower string line adapter blade device of claim 1, wherein the fastener is a screw, a bolt or a magnet.

3. The lawnmower string line adapter blade device of claim 1, wherein the body is manufactured from a stainless steel, an aluminum or a hot-rolled mild steel.

4. The lawnmower string line adapter blade device of claim 1, wherein each of the central fastener opening, the central string opening, and the perimeter string opening is a continuous opening.

5. The lawnmower string line adapter blade device of claim 1, wherein the body is circular in shape.

6. A lawnmower string line adapter blade device comprising:
a body having a central fastener opening, a central string opening positioned around the central fastener opening, and a perimeter string opening positioned around each of the central fastener opening and the central string opening;
a fastener; and
a nylon string.

7. The lawnmower string line adapter blade device of claim 6, wherein the fastener is a screw, a bolt, or a magnet.

8. The lawnmower string line adapter blade device of claim 6, wherein the body is manufactured from a rigid plastic.

9. The lawnmower string line adapter blade device of claim 6, wherein each of the central fastener opening, the central string opening, and the perimeter string opening are continuous.

10. The lawnmower string line adapter blade device of claim 6, wherein the body is circular in shape.

11. A lawnmower string line adapter blade device comprising:
a circular body having a central fastener opening, a plurality of central string openings positioned radially around the central fastener opening, and a plurality of perimeter string openings positioned radially around the central fastener opening and around the plurality of central string openings;
a fastener; and
a nylon string.

12. The lawnmower string line adapter blade device of claim 11, wherein the fastener is a screw, a bolt, or a magnet.

13. The lawnmower string line adapter blade device of claim 11 further comprised of a nut and a washer.

14. The lawnmower string line adapter blade device of claim 11, wherein the plurality of central string openings are arranged in a paired configuration around the center fastener opening.

15. The lawnmower string line adapter blade device of claim 11, wherein the plurality of perimeter string openings are arranged in a paired configuration around the plurality of central string openings and around the center fastener opening.

16. The lawnmower string line adapter blade device of claim 11, wherein the nylon string is cylindrical in shape.

17. The lawnmower string line adapter blade device of claim 16, wherein the nylon string is manufactured from a hardened monofilament nylon.

18. The lawnmower string line adapter blade device of claim 11 further comprised of a plurality of nylon strings.

19. The lawnmower string line adapter blade device of claim 18, wherein the plurality of nylon strings are pre-cut to a desired length.

20. The lawnmower string line adapter blade device of claim 11, wherein each of the central fastener opening, the plurality of central string openings, and the plurality of perimeter string openings is continuous.
